(19) United States
(12) Patent Application Publication
(10) Pub. No.: US 2013/0026689 A1
(43) Pub. Date: Jan. 31, 2013

(54) VIBRATION ISOLATION DEVICE AND SYSTEM

(71) Applicants: David Bloomfield, Redmond, WA (US); Tabb Firchau, Redmond, WA (US)

(72) Inventors: David Bloomfield, Redmond, WA (US); Tabb Firchau, Redmond, WA (US)

(73) Assignee: FREEFLY SYSTEMS INC., Redmond, WA (US)

(21) Appl. No.: 13/554,932

(22) Filed: Jul. 20, 2012

Related U.S. Application Data
(60) Provisional application No. 61/574,971, filed on Aug. 12, 2011.

(51) Int. Cl. F16F 1/373; F16F 3/093

(52) U.S. Cl. 267/140.3; 267/141; 267/141.1

(57) ABSTRACT

An adjustable vibration reduction device is provided to dampen and reduce vibration in order to maintain performance of equipment attached to a system. The vibration reduction device includes at least one resilient vibration dampener coupling an upper assembly to a lower assembly. The upper assembly is attached to an equipment mount frame via a pair of stop members extending through a pair of stop apertures in the lower assembly to control movement of the lower assembly relative to the upper assembly. The lower assembly is attached to a structure frame via a pair of fastening devices. The vibration reduction device may be adjusted by selectively including at least one resilient vibration dampener, such as an o-ring, having predetermined characteristics to maximize vibration reduction or isolation. A plurality of vibration reduction devices are provided in a system that causes or transfers vibration, such as a vehicle, having electronic equipment attached thereto.

### CROSS-REFERENCE TO RELATED APPLICATION

This application claims the benefit under 35 U.S.C. §119(e) of U.S. Provisional Patent Application No. 61/574,971 filed Aug. 12, 2011.

### BACKGROUND

1. Technical Field

This disclosure is generally related to vibration dampeners, and more particularly, to adjustable vibration reduction devices that reduce or isolate vibration to maintain performance of electronic equipment attached to structures.

2. Description of the Related Art

Numerous systems having electrical and optical components require minimal vibration in order to maximize operability and performance. Such systems include, for example, audio equipment, medical devices, and vehicles such as airplanes, automobiles, helicopters, boats and the like. Vibration caused by internal or external forces can affect the performance of these systems, thereby reducing the quality of images and video. Premature equipment failure may also result if vibration is not reduced or isolated. Many devices and systems exist that incorporate features to counteract the effect of vibration on such equipment. There are faults, however, with many of such devices and systems, such as the lack of adjustability and the lack of control over displacement when the system experiences unusual forces and vibration. Furthermore, many systems merely control displacement of the components of the system in one or two axes when fully constrained control is required to reduce or isolate vibration and prevent chatter.

### BRIEF SUMMARY

Embodiments of the present invention provide a device and system that assist with damping or absorbing vibration experienced by a system. More particularly, a vibration reduction device is provided to maintain performance of electronic equipment attached to a particular structure or system, such as a vehicle that causes or transfers vibration to electronic equipment when in operation. A plurality of vibration reduction devices may be installed in such structure or system. Each vibration reduction device includes at least one resilient vibration dampener, such as an o-ring or plurality of o-rings, which provides the ability to “tune” the device to a desired stabilization by selectively including the number and type of o-rings in the device. Such feature provides the ability to tune the plurality of devices attached to the structure or system to reduce or isolate vibration caused by motors, for example, while the structure or system is in use. Each vibration reduction device further includes stop and travel limit features that limit and control the displacement of each device to improve functionality of the vibration reduction device and components of the system. It will be appreciated that the vibration reduction devices and systems described herein may be used in conjunction with filming equipment, vehicles, optical devices, imaging devices, and electrical equipment applications. In particular, the vibration reduction devices may be used in motorized or remote control vehicles, such as helicopters, airplanes, cars, trucks, and the like. Moreover, the vibration reduction devices may be used in non-motorized vehicles and other applications, such as on bicycles, sporting and recreational equipment, helmets, and the like.

In one embodiment, a vibration reduction device includes at least one resilient vibration dampener, an upper assembly, and a lower assembly. The lower assembly and the upper assembly are removably coupled to one another by the at least one resilient vibration dampener, which is at least partially positioned between the upper assembly and lower assembly. The upper assembly is adapted to fixedly attach to a structure and the lower assembly configured to fixedly attach to a mount frame when the vibration reduction device is installed for use on a vehicle, for example. The mount frame includes at least one electronic equipment mounted thereto, which may include at least one of a camera, a global positioning satellite device, a computing system, or an electrical system which may operate remotely or locally to the vehicle. The structure of the vehicle may include at least one mechanical assembly that causes vibration when the vehicle is in use, such as at least one of an electric motor having a rotor attached thereto, a combustion engine, or mechanical device configured to fly or move the vehicle. The mount frame and the structure, therefore, are elastically coupled to one another by the at least one resilient vibration dampener. For purposes of the embodiments described herein, an elastic o-ring is provided as the at least one resilient vibration dampener. It will be appreciated, however, that many other suitable resilient vibration damping devices may be incorporated into the embodiments discussed herein, whether presently known or hereafter.

Turning now to the upper assembly, the upper assembly includes an upper retainer member and an upper spacer member attached to one another with an upper fastening device. An upper portion of the o-ring is coupled and closely held between portions of the upper retainer member and the upper spacer member. Similarly, the lower assembly includes a lower retainer member and a lower spacer member attached to one another with a lower fastening device. A lower, opposing portion of the o-ring is coupled and closely held between portions of the lower retainer member and the lower spacer member. The upper fastening device is removably attached to the mount frame and the lower fastening device is removably attached to the structure. Thus, a portion of the upper spacer member is disposed through an upper area of an aperture in the o-ring and a portion of the lower spacer member is similarly disposed through a lower area of the aperture of the o-ring. It will be appreciated that the upper assembly and the lower assembly may be constructed of any rigid material, such as metal, polymer, fiberglass, carbon, or other suitable materials presently known or later developed.

In another embodiment, the vibration reduction device includes at least one stop member fastened to the upper assembly. The at least one stop member is adapted to act as a stop (or travel limit) when the vibration reduction device is installed for use to control relative movement of the upper assembly relative to the lower assembly and to control displacement of the at least one resilient vibration dampener. In a further embodiment, the at least one stop member comprises a pair of stop members that each comprise a portion of the upper fastening device. The lower assembly includes a pair of stop portions through which the pair of stop members are spatially positioned adjacent to and through respective stop portions of the lower assembly. In this example, the stop portions are corresponding apertures in the lower retainer member and lower spacer member that act as a travel limit when one of the upper assembly or lower assembly is displaced relative to the other one of the upper assembly or lower assembly. The size and shape of the stop members and corresponding apertures are determined by a desired displacement distance of the vibration reduction device. For example, the corresponding apertures may vary in shape and size to accommodate a desired displacement distance.

This system of stop members and corresponding apertures control the amount of movement of the upper assembly relative to the lower assembly (or vice versa) in order to prevent over displacement, while experiencing axial forces, of one of the upper or lower assemblies when the vehicle is in use. In one embodiment, the pair of stop members are each a mounting device that is adapted to removably attach the upper assembly to the mount frame. The mounting device may be a hex nut with a threaded bore for receiving a bolt attached to the mount frame. It will be appreciated that the stop members may be included on the lower assembly and the corresponding apertures may be formed on the upper assembly while still achieving the desired result.

In a further embodiment, the vibration reduction device is tunable. The operator may selectively include or exclude a plurality of o-rings into the vibration reduction device, or may include or exclude a variety of differing o-rings in a plurality of vibration reduction devices within an entire system. Depending upon the particular application (e.g., overall mass of the vehicle, number of motors, type of electronic equipment, external environment factors), the operator may include one or more o-rings (or other resilient dampeners) having at least one or more of predetermined characteristics. These characteristics may include a deflection rate, size, shape, thickness, color, elasticity, resilience, permeability, material, tensile strength, or compression strength. Many such o-rings are available for purchase; however, custom o-rings may be created to suit particular needs of vibration isolation of a system or vehicle.

The o-ring of the vibration reduction device includes, as with many available o-rings, an aperture, an outer area, an inner area, an upper portion, and a lower portion. The upper portion of the o-ring may be coupled between the upper retainer member and the upper spacer member such that a portion of the inner area of the upper portion of the o-ring is biased between portions of the upper spacer member and the upper retainer member. The upper retainer member may include at least one slot in which to receive said upper portion of the o-ring, and, therefore, a portion of the upper spacer member is positioned through the upper area of the aperture of the o-ring. Similarly, the lower portion of the o-ring is coupled between the lower retainer member and the lower spacer member such that a portion of the inner area of the lower portion of the o-ring is biased between the lower spacer member and the lower retainer member. Additionally, the lower retainer member may include at least one slot in which to receive said lower portion of the o-ring, and, therefore a portion of the upper spacer member is positioned through the lower area of the aperture of the o-ring. In this embodiment, the slots of the upper and lower retainer members are adapted to at least partially expose the upper and lower portions of the o-ring and hold it closely between the upper assembly and the lower assembly (FIGS. 1A, 3A, and 3B). Thus, at least one o-ring is positioned vertically relative to a horizontal surface of the upper assembly and a horizontal surface of the lower assembly.

In the embodiments described above, the plurality of o-rings may include six o-rings annularly aligned in a row and positioned vertically and perpendicularly relative to the horizontal surfaces of the upper and lower assemblies. It will be appreciated that the o-rings may be positioned in a variety of differing configurations while providing the desired functionality of the vibration reduction device to the vehicle or system.

In another embodiment, the vibration reduction device includes at least one stop member comprising a pair of stop members attached to the upper assembly. The pair of stop members are adapted to each extend through corresponding apertures in the lower assembly. Similar to the discussion above, the corresponding apertures of the lower assembly act as a travel limit when one of the upper assembly or lower assembly is displaced relative to the other one of the upper assembly or lower assembly. In this embodiment, the plurality of o-rings are positioned between the upper and lower assemblies in a non-annular configuration. Four pairs of o-rings are each positioned between the upper assembly and the lower assembly at a 90 degree angle relative to adjacent pairs of o-rings (FIG. 4). Inverse to the embodiment of FIGS. 1A-3B, the upper assembly is secured to the structure above the device via fasteners attached to the structure and threaded holes in the upper assembly. Similarly, the lower assembly is secured to the mount frame below the device via fasteners attached to the mount frame and threaded holes in the lower assembly.

In another embodiment, a plurality of pairs of o-rings are positioned in a circular shape and evenly distributed throughout the vibration reduction device and at an acute angle relative to adjacent pairs of o-rings (FIG. 5). In this example, a plurality of stop members and corresponding apertures are provided in the vibration reduction device, similar to the description above regarding FIG. 1A-3B. In this example, the plurality of stop members (hex nuts) comprise a first and second set of stop members wherein the first set of stop members extend from the upper assembly through corresponding apertures in the lower assembly to fixedly attach to the mount frame. The second set of stop members extend from the lower assembly through corresponding apertures in the upper assembly to fixedly attach to the structure.

In yet another embodiment, a vibration reduction device is provided for reducing the amount of vibration transferred from a carrier (such as the structure) to an electronic device to be carried to the carrier. The vibration reduction device includes a lower assembly adapted to be fixedly coupled to the carrier, such that the lower assembly has an upper surface oriented to be facing upward during use of the vibration reduction device. The vibration reduction device may include an upper assembly adapted to be fixedly coupled to the electronic device, such that the upper assembly having a lower surface oriented to be facing downward during use of the vibration reduction device. In this example, at least a portion of the upper assembly may be positioned directly above at least a portion of the lower assembly such that the upper surface and lower surface are facing each other during use. At least one compressible, resilient body is therefore positioned between the upper surface of the lower assembly and the lower surface of the upper assembly, such that the weight of the electronic device is borne by the at least one compressible, resilient body when the vibration reduction device is used to carry the electronic device from the carrier. In this example, at least some the vibration of the carrier may be absorbed by the at least one compressible, resilient body instead of being transferred to the electronic device.

It will be appreciated that any particular system may include a combination of a plurality of the vibration reduction devices described above, including varying types of o-rings and configurations to provide a desired vibration damping effect while vibration is experienced by the system.

### BRIEF DESCRIPTION OF THE SEVERAL VIEWS OF THE DRAWINGS

FIG. 1A is an isometric view of a vibration reduction device according to one embodiment.

FIG. 1B is another isometric view of the vibration reduction device of FIG. 1A.

FIG. 2A is an isometric exploded view of the vibration reduction device of FIG. 1A, showing the o-rings encircling the spacer members.

FIG. 2B is an isometric exploded view of the vibration reduction device of FIG. 1A, showing the o-rings exploded from the spacer members.

FIG. 3A is a cross-sectional view of the vibration reduction device of FIG. 1A, viewed along section 3A-3A.

FIG. 3B is a cross-sectional view of the vibration reduction device of FIG. 1A, viewed along section 3A-3A.

FIG. 4 is an isometric view of a vibration reduction device, according to another embodiment.

FIG. 5 is an isometric view of a vibration reduction device, according to yet another embodiment.

FIG. 6 is an isometric view of a device incorporating a plurality of the vibration reduction devices of FIG. 1A.

FIG. 7 is an isometric view of a vibration reduction device installed in a remote controlled vehicle.

### DETAILED DESCRIPTION

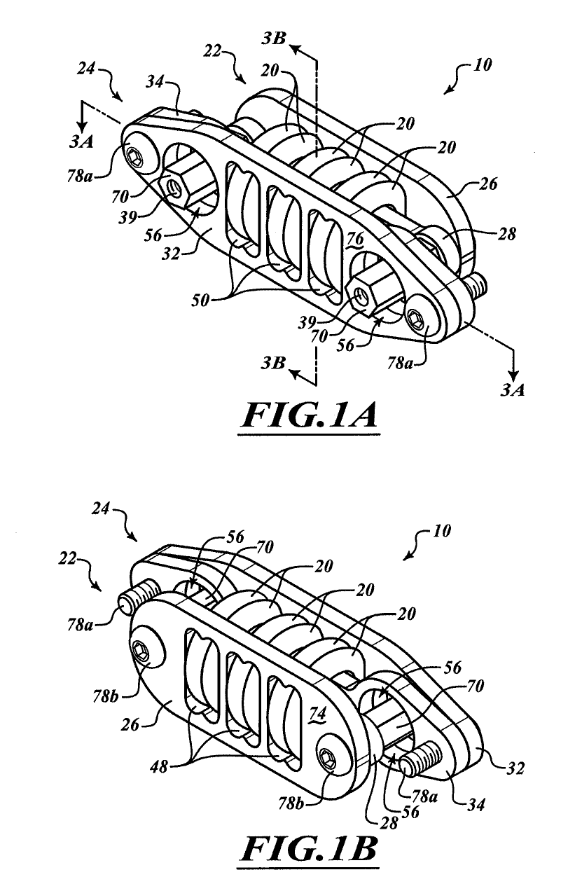

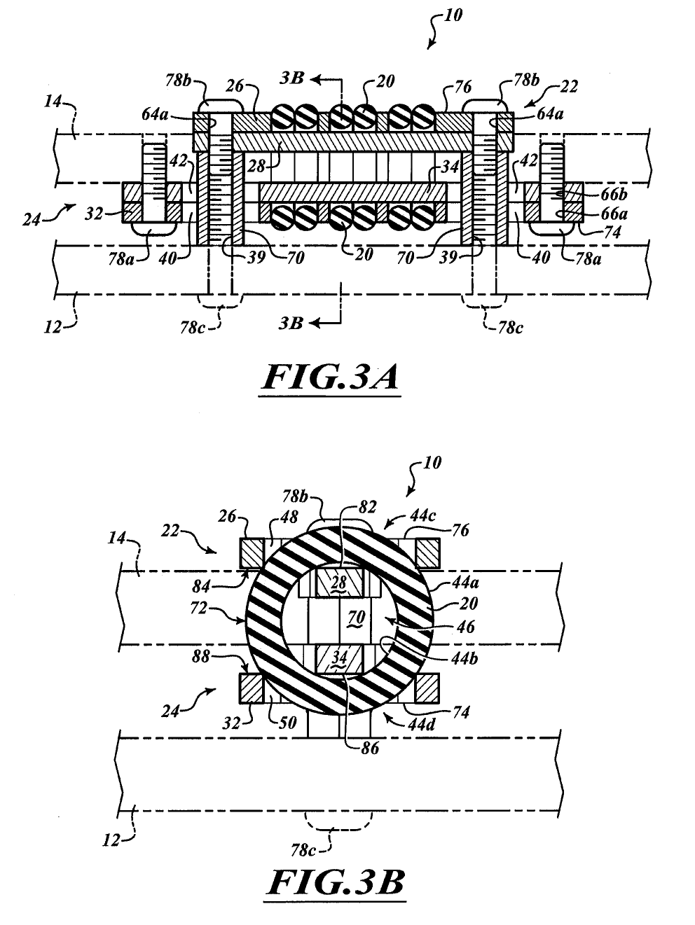

FIGS. 1A and 1B show one example embodiment of a vibration reduction device 10 having six o-rings 20, an upper assembly 22, and a lower assembly 24. The upper assembly 22 is configured to attach to a mount frame via hex nuts 70, and the lower assembly 24 is configured to attach to a structure via bolts 78a (FIGS. 3A and 3B). The upper assembly 22 includes an upper retainer member 26 and an upper spacer member 28 attached to one another between the hex nuts 70 and bolts 78b. The lower assembly 24 includes a lower retainer member 32 and a lower spacer member 34 attached to one another between the bolt 78a and another hex nut (not shown) of the structure 14. Hex nuts 70 include threaded bores 39 for receiving bolts 78c from the mount frame to firmly secure thereto (FIGS. 3A and 3B).

Slots 50 in the lower retainer member 32 closely receive lower portions of the o-rings 20. Similarly, slots 48 of the upper retainer member 26 closely receive upper portions of the o-rings 20. It will be appreciated that slots 48 and slots 50 may instead be biased against recessed portions in the upper and lower retainer members, thereby hiding the upper and lower portions of the o-rings 20 from view. Corresponding stop apertures 56 are provided through the lower assembly 24 to allow passage of hex nuts 70 and to act as a transverse travel limit. This is one of the “stop” configurations discussed above. In this embodiment, the o-rings 20 are annularly aligned in a row and positioned vertically and perpendicularly relative to horizontal surface 74 of the upper assembly 22 and horizontal surface 76 of the lower assembly 24 (see FIG. 3A).

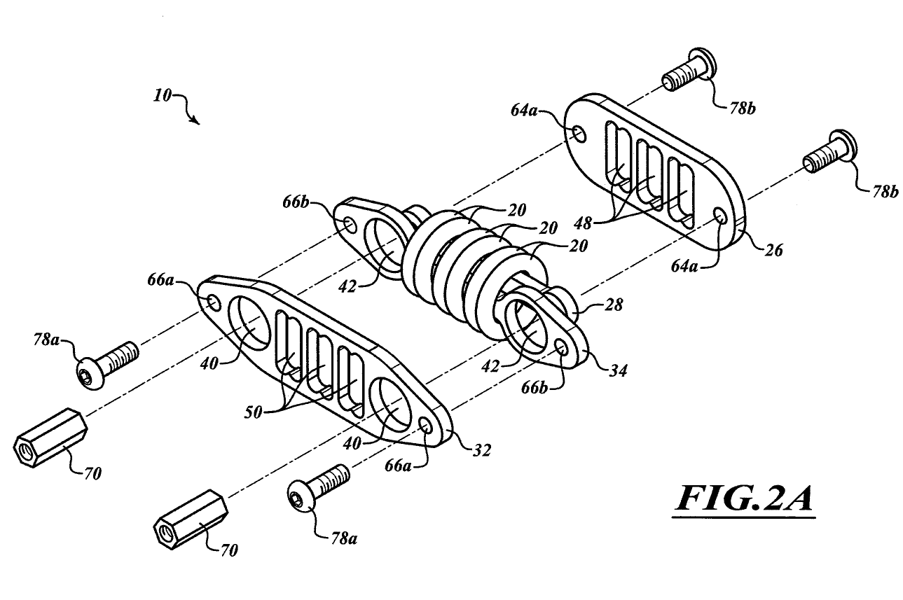

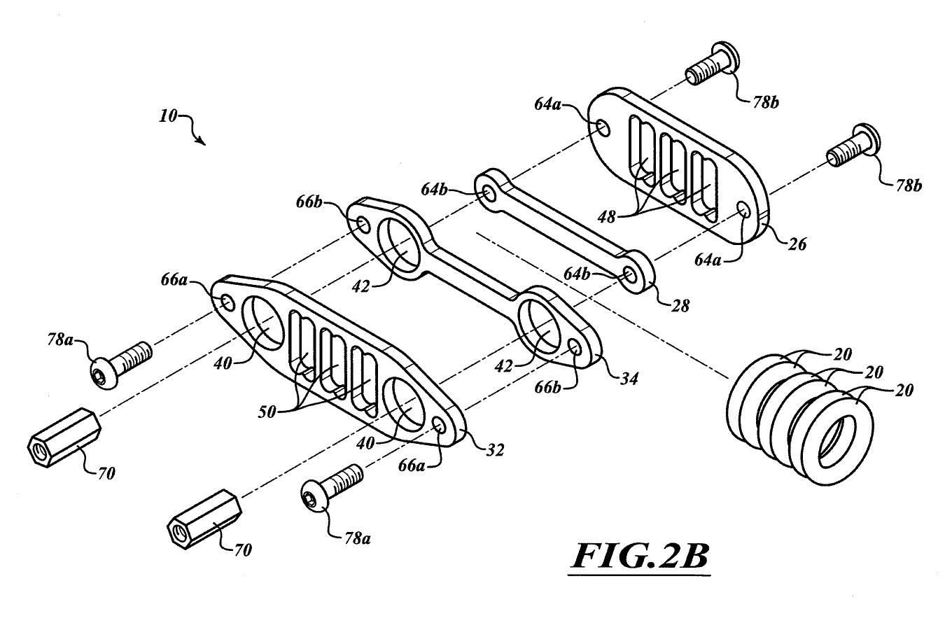

FIG. 2A shows the vibration reduction device 10 having o-rings 20 encircling central portions of the upper spacer member 28 and the lower spacer member 34. The upper spacer member 28 and the lower spacer member 34, therefore, can be “dog-bone” shaped to allow passage through the o-ring apertures. Holes 66a and 66b receive bolts 78a, which can be threaded into holes in the structure frame 14 to firmly attach thereto (FIGS. 3A and 3B). Likewise, holes 64a and 64b can receive bolts 78b, which are received by hex nuts 70, at one end, and bolts 78c at the opposing end, through holes in the mount frame 12 (FIGS. 3A and 3B). Slots 48 and 50 can be formed in an oval-shape to closely hold a pair of o-rings 20 pressed thereto. As shown in FIG. 2B, a number of o-rings 20 may be included into the vibration reduction device 10 before installation to provide desired damping properties to the vehicle or system. Lower retainer member apertures 40 and lower spacer member apertures 42 comprise the corresponding apertures 56, as discussed above, through which to spatially receive the hex nuts 70. When the vibration reduction device 10 is constructed (FIG. 1A), the holes 64a, 64b, bolts 78b, hex nuts 70, and stop transverse apertures 56 are aligned about their respective, common axes, as shown in FIGS. 2A and 2B. The same alignment is true at the opposing side of the illustrated embodiment.

FIG. 3A shows the vibration reduction device 10, cut along its central longitudinal and vertical axes. This view shows o-rings 20 closely held in the upper assembly 22 between the upper spacer member 28 and the upper retainer member 26 at the upper portion 44c of the o-rings 20. Similarly, the lower portion 44d of the o-rings 20 are closely held in the lower assembly 24 between the lower spacer member 34 and the lower retainer member 32 (FIG. 3B). The upper assembly 22 is attached to the mount frame 12 via bolts 78b, threaded into hex nuts 70 on one end, and via bolts 78c received through mount frame 12 and into threaded bore 39 of the other end of hex nuts 70. The lower assembly 24 is attached to the structure frame 14 via bolts 78a, through holes 66a and 66b of the upper spacer member 28 and the upper retainer member 26, respectively, and threaded into holes in the structure frame 14. It will be appreciated that various types of fasteners and connections may be used to couple the upper and lower assemblies to the mount and structure frames while maintaining the elastically coupled configuration between the upper and lower assemblies.

FIG. 3B shows the o-rings 20 as closely held to the upper assembly 22 at the upper portion 44c of the o-ring and to the lower assembly 24. This view shows o-rings 20 having an inner area 44b and an outer area 44a. The inner area 44b of the upper portion 44c rests against an upper surface 82 of the upper spacer member 28, while the outer area 44a of the upper portion 44c rests against a lower surface 84 of the upper retainer member 26. The inner area 44b of the lower portion 44d rests against a lower surface 86 of the lower spacer member 34, while the outer area 44a of the lower portion 44d rests against a lower surface 88 of the lower retainer member 32. It is shown in FIGS. 3A and 3B that, in the illustrated embodiment, the upper assembly 22 and the lower assembly 24 are only attached to one another by respective portions of the o-rings 20. Thus, the mount frame 12 and structure frame 14 are elastically coupled and “float” relative to one another about the o-rings 20 while a plurality of vibration reduction devices are installed, for example.

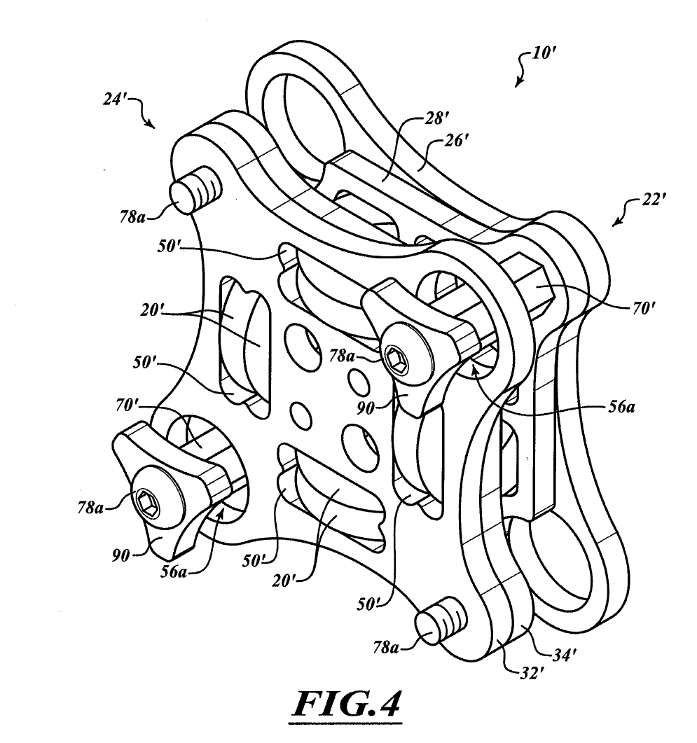

FIG. 4 shows another embodiment of a vibration reduction device 10′ having a pair of hex nuts 70′ that extend through corresponding apertures 56a of the lower retainer member 32′. Corresponding apertures 56a, therefore, act as a transverse travel limit, similar to the descriptions above. A pair of resisters 90 can be attached to hex nuts 70′ by bolts 78a to act as a longitudinal stop to prevent the hex nuts from over extending through the corresponding stop apertures 56a during extraordinary displacement. Four pairs of o-rings 20′ are positioned between the upper assembly 22′ and the lower assembly 24′. The four pairs of o-rings 20′ are each positioned at a 90 degree angle relative to the adjacent pairs of o-rings. The lower retainer member 32′ and lower spacer member 34′ are attached to a mount frame (not shown) via bolts 78a. The upper assembly 22′ is attached to a structure frame via fasteners into threaded holes (not shown) in the upper retainer member 32′. Upper spacer member 28′ and lower spacer member 34′ are formed in a particular configuration having a variety of apertures and cross members (hidden) to closely receive the four pairs of o-rings 20, similar to the manner described above related to FIGS. 1A-3B. Slots 50 are also provided in the lower retainer member 32′, as with slots 48 (hidden) in the upper retainer member 26′, to closely hold the o-rings in place.

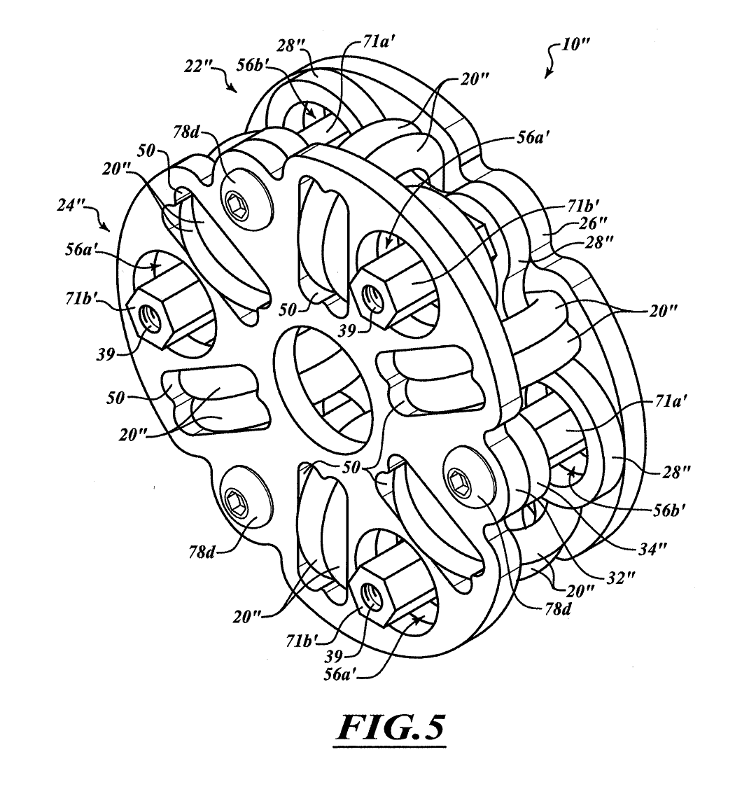

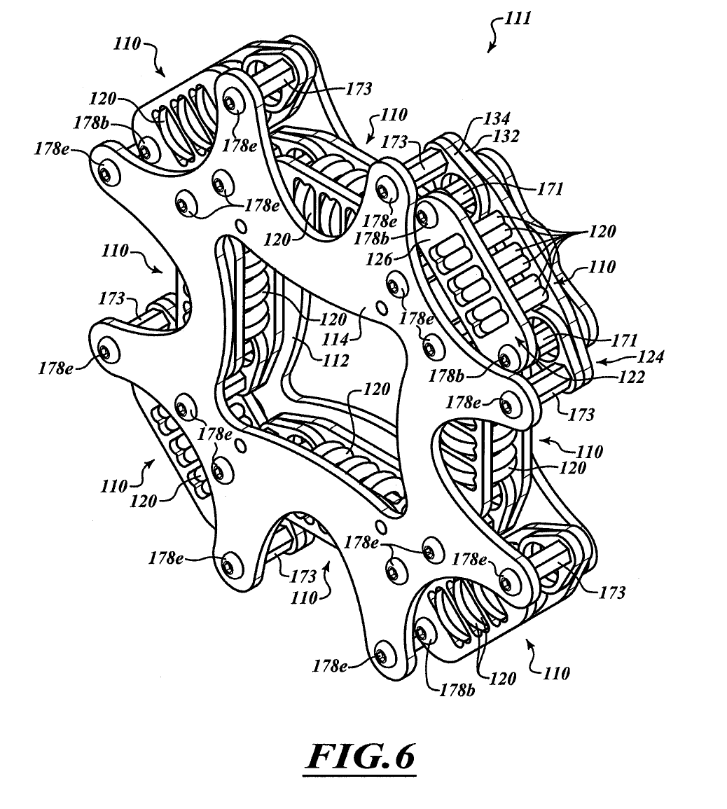

FIG. 5 shows another embodiment of a vibration reduction device 10″ having six pairs of o-rings 20″ arranged radially in a circular configuration and having a plurality of hex nuts 71a′ and 71b′ disposed through corresponding stop apertures 56b′ and 56a′, respectively. Similar to the description of FIG. 4, the vibration reduction device 10″ includes a set of three hex nuts 71a′ secured to the upper assembly 22″ via bolts (not shown) and extending through corresponding apertures 56b′. A supplemental set of three hex nuts 71b′ are provided, as secured to the lower assembly 24″ via bolts 78d, and extending through stop apertures 56a′. Upper spacer member 28″ and lower spacer member 34″ are formed having a particular configuration having a variety of apertures and cross members (not shown) to closely receive the six pairs of o-rings 20″, in a similar to manner as described above related to FIGS. 1A-3B. Slots 50 are also provided in the lower retainer member 32″, as with slots 48 in the upper retainer member 26″, to closely hold o-rings 20″ in place.

FIG. 6 shows a plurality of the vibration reduction devices 110, similar to those shown in FIGS. 1A-3B, secured to mount frame 112 and structure frame 114. In this example, eight vibration reduction devices 110 are included into vibration isolation system 111. As previously discussed, the upper assembly 122 is attached to the mount frame 112 via hex nuts 171 and bolts 178b and bolts (not shown) through the backside of mount frame 112. The lower assembly 124 is attached to the structure frame 114 via hex nuts 173 and bolts 178e. In this embodiment, the vibration reduction devices 110 are arranged at slight angles relative to one another, thereby providing multiple o-rings 120 in varying angular configurations relative to one another. This configuration, as with the configurations of FIGS. 4 and 5, provide vibration reduction devices and systems having multi-axial control means for optimal vibrational and directional control while the system is in use. It will be appreciated that any particular system may include a combination of a plurality vibration reduction devices described above, including varying types of o-rings and configurations to provide a desired vibration damping effect when operating the system while it experiences vibration.

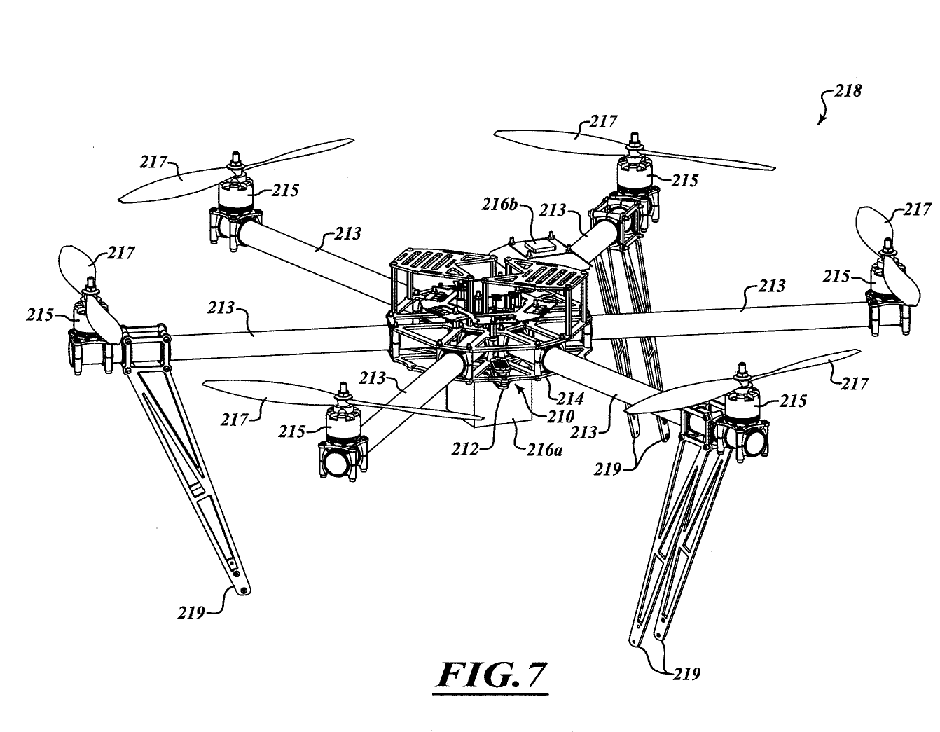

FIG. 7 shows the vibration reduction device 210 installed on a remote controlled vehicle 218. The vehicle 218 includes a mount frame 212 (mostly hidden) having a camera 216a attached thereto, and a structure frame 214. Attached to the structure frame 214 is a global positioning satellite device 216b, six booms 213, and landing gear 219. Attached to the booms 213 are motors 215 having propellers 217 for flying the vehicle 218. In this vehicle, three vibration reduction devices 210 are provided and positioned equidistant from one another, resulting in approximately 110 degree angles between each vibration reduction device 210. As described above, each vibration reduction device 210 is attached to the structure frame 214 via bolts 78a coupled to the lower assembly 24, and attached to the mount frame 212 via hex nuts 70 and bolts 78b coupled to the upper assembly 22 (FIGS. 1A-3B).

A method of reducing vibration between two or more structures of a vehicle may also be provided in which any of the above embodiments of the vibration reduction devices may be installed. A method of tuning such vibration reduction devices may also be provided by selectively including particular o-rings, as discussed above. A further method of limiting travel between the upper and lower assembly may also be provided by incorporating the stop features discussed above.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A vibration reduction device to control relative movement between a mount frame adapted to mount electronics and a structure that causes or transfers vibration to the mount frame, the vibration reduction device comprising:
at least one resilient vibration dampener;
an upper assembly; and
a lower assembly, the lower assembly and the upper assembly removably coupled to one another by the at least one resilient vibration dampener at least partially positioned between the upper assembly and the lower assembly; and
wherein the upper assembly is adapted to fixedly attach to the mount frame and the lower assembly is adapted to fixedly attach to the structure when the vibration reduction device is installed for use, whereby the mount frame and structure are elastically coupled by the at least one resilient vibration dampener.

2. The device of claim 1 wherein the upper assembly includes an upper retainer member and an upper spacer member attached to one another with an upper fastening device and collectively coupled to a first portion of the at least one resilient vibration dampener, and wherein the lower assembly includes a lower retainer member and a lower spacer member attached to one another with a lower fastening device, and collectively coupled to a second portion of the at least one resilient vibration dampener opposite the first portion.

3. The device of claim 2 wherein the upper fastening device is removably attached to the mount frame, and wherein the lower fastening device is removably attached to the structure.

4. The device of claim 1 wherein at least one stop member is coupled to at least one of the upper assembly and one of the lower assembly, such that the at least one stop member is adapted to act as a travel limit when the vibration reduction device is installed for use to control movement of the upper assembly relative to the lower assembly and to control displacement of the at least one resilient vibration dampener.

5. The device of claim 4 wherein the at least one stop member comprises a pair of stop members, wherein each of the pair of stop members comprises a fastening device of the upper fastening device, wherein the lower assembly includes a pair of stop portions in which a portion of each of the pair of stop members is spatially positioned adjacent to respective stop portions of the lower assembly such that the stop portions act as a travel limit when one of the upper assembly and the lower assembly is displaced relative to the other one of the upper assembly and the lower assembly up to a displaced distance that is determined by the configuration of the pair of stop portions relative to the pair of stop members.

6. The device of claim 5 wherein the pair of stop portions comprise a pair of apertures in the lower spacer member and lower retainer member in which each of the pair of stop members is spatially positioned through one of the pair of apertures.

7. The device of claim 5 wherein the pair of stop members include a mounting device that is adapted to removably attach the upper assembly to the mount frame.

8. The device of claim 1 wherein the device is adapted to selectively include or exclude a plurality of resilient vibration dampeners, in which the selected plurality of resilient vibration dampeners each includes at least one of a predetermined characteristic comprising a deflection rate, size, shape, thickness, color, elasticity, resilience, permeability, material, tensile strength, or compression strength, such that the selection of the predetermined characteristics of the at least one resilient vibration dampener is determinative of a load coupled to the frame mount and a vibration caused by the structure when the device is in use.

9. The device of claim 1 wherein the at least one resilient vibration dampener is an o-ring having an aperture and an outer area and an inner area, wherein an upper portion of the o-ring is coupled between the upper retainer member and the upper spacer member, such that a portion of the inner area of the upper portion of the o-ring is biased against a portion of an upper surface of the upper spacer member, and such that a portion of the outer area of the upper portion of the o-ring is biased against a portion of a lower surface of the upper retainer member, the upper retainer member including at least one slot in which to receive said upper portion of the o-ring, and wherein the upper spacer member is partially positioned through the aperture of the o-ring.

10. The device of claim 1 wherein the at least one resilient vibration dampener is an o-ring having an aperture and an outer area and an inner area, wherein a lower portion of the o-ring is coupled between the lower retainer member and the lower spacer member, such that a portion of the inner area of the lower portion of the o-ring is biased against a portion of a lower surface of the lower spacer member, and such that a portion of the outer area of the lower portion of the o-ring is biased against a portion of an upper surface of the lower retainer member, the lower retainer member including at least one slot in which to receive said lower portion of the o-ring, and wherein the lower spacer member is partially positioned through the aperture of the o-ring.

11. The device of claim 1 wherein the o-ring is oriented vertically relative to a horizontal surface of the upper assembly and a horizontal surface of the lower assembly.

12. The device of claim 3 wherein the at least one stop member comprises a first plurality of stop members attached to the upper assembly and a second plurality of stop members attached to the lower assembly, wherein the first plurality of stop members are adapted to each extend through corresponding apertures in the lower assembly, and wherein the second plurality of stop members are adapted to extend through corresponding apertures in the upper assembly, wherein the corresponding apertures of the upper and lower assemblies act as a travel limit when one of the upper assembly or lower assembly is displaced relative to the other one of the upper assembly or lower assembly.

13. A system for reducing vibration comprising at least one of the vibration reduction device of claim 1 adapted to elastically couple components of a vehicle, wherein the vehicle includes a mount frame having at least one electronic equipment mounted thereto and a structure having at least one mechanical assembly adapted to cause vibration when in use, wherein the at least one resilient vibration dampener of the device is selectively included to assist with reducing vibration caused by the at least one mechanical assembly while the vehicle is in operation.

14. The system of claim 13 wherein the at least one electronic equipment comprises at least one of a camera, a global positioning satellite device, a computing system, or an electrical system, wherein the at least one electronic equipment is adapted to operate remotely or locally, and wherein the at least one mechanical assembly comprises at least one of an electric motor having a rotor or propeller attached thereto, a combustible engine, or mechanical system configured to fly or move the vehicle while in operation.

15. The system of claim 13 wherein the at least one of the device of claim 1 includes a plurality of devices of claim 1 adapted to elastically couple the mount frame to the at least one mechanical assembly.

16. A system for reducing vibration between a mount frame adapted to mount electronics and a structure adapted to cause vibration, the system comprising:
a plurality of vibration reduction devices, each device comprising:
at least one resilient vibration dampener;
an upper assembly; and
a lower assembly, the upper assembly and the lower assembly removably coupled to one another by the at least one resilient vibration dampener at least partially positioned between the upper assembly and the lower assembly;
wherein the each upper assembly of the plurality of vibration reduction devices is removably attached to the structure, and wherein each lower assembly of the plurality of vibration reduction devices is removably attached to the mount frame when the plurality of vibration reduction devices are installed for use, whereby the mount frame and structure are elastically coupled by the resilient vibration dampeners of the plurality of vibration reduction devices.

17. The system of claim 16 wherein the upper assembly includes an upper retainer member and an upper spacer member attached to one another with an upper fastening device and collectively coupled to a first portion of the at least one resilient vibration dampener, and wherein the lower assembly includes a lower retainer member and a lower spacer member attached to one another with a lower fastening device, and collectively coupled to a second portion of the at least one resilient vibration dampener opposite the first portion.

18. The system of claim 16 wherein the upper fastening device is removably attached to the mount frame, and wherein the lower fastening device is removably attached to the structure.

19. The system of claim 16 wherein at least one stop member is coupled to at least one of the upper assembly and one of the lower assembly, wherein the at least one stop member is adapted to act as a travel limit when the vibration reduction device is installed for use to control movement of the upper assembly relative to the lower assembly and to partially control displacement of the at least one resilient vibration dampener.

20. The system of claim 19 wherein the at least one stop member comprises a pair of stop members, wherein the pair of stop members are each a fastening device of the upper fastening device, wherein the lower assembly includes a pair of stop portions in which a portion of each of the pair of stop members are spatially positioned adjacent to respective stop portions of the lower assembly such that the stop portions act as a travel limit when one of the upper assembly or lower assembly is displaced relative to the other one of the upper assembly or lower assembly up to a displacement distance that is determined by the configuration of the pair of stop portions relative to the pair of stop members.

21. The system of claim 20 wherein the pair of stop portions are a pair of apertures in the lower spacer member and lower retainer member in which each of the pair of stop members are spatially positioned through one of the pair of apertures, and wherein the pair of stop members include a mounting device that is adapted to removably attach the upper assembly to the mount frame.

22. The system of claim 16 wherein the device is adapted to selectively include or exclude a plurality of resilient vibration dampeners, wherein the selected plurality of resilient vibration dampeners each includes at least one of a predetermined characteristic comprising at least one of a deflection rate, size, shape, thickness, color, elasticity, resilience, permeability, material, tensile strength, or compression strength, such that the selection of the predetermined characteristics of the at least one resilient vibration dampener is determinative of a load coupled to the frame mount and a vibration caused by the structure when the device is in use.

23. The system of claim 16 wherein the at least one resilient vibration dampener comprises an o-ring, wherein an upper portion of the o-ring is coupled between the upper retainer member and the upper spacer member, the upper retainer member including at least one slot in which to receive said upper portion of the o-ring, and wherein the upper spacer member is partially positioned through the aperture of the o-ring, and further wherein a lower portion of the o-ring is coupled between the lower retainer member and the lower spacer member, the lower retainer member including at least one slot in which to receive said lower portion of the o-ring, and wherein the lower spacer member is partially positioned through the aperture of the o-ring.

24. The system of claim 16 wherein the first structure is a mount frame having at least one electronic equipment mounted thereto, and the second structure includes at least one mechanical assembly adapted to cause vibration when the system is in use, wherein the at least one resilient vibration dampener of the device is selectively configured to assist with reducing vibration caused by the at least one mechanical assembly while the vehicle is in operation.

25. The system of claim 24 wherein the at least one electronic equipment comprises at least one of a camera, a global positioning satellite device, a computing system, or an electrical system, wherein the at least one electronic equipment is adapted to operate remotely or locally, and wherein the at least one mechanical assembly comprises at least one of an electric motor having a rotor or propeller attached thereto, a combustible engine, or mechanical system.

26. A vibration reduction device for reducing vibration between a first structure and a second structure, the vibration reduction device comprising:
at least one o-ring having an aperture and an upper portion and a lower portion;
an upper assembly comprising an upper retainer member and an upper spacer member attached to one another with an upper fastening device, the upper retainer member and the upper spacer member collectively coupled to an upper portion of the at least one o-ring;
a lower assembly comprising a lower retainer member and a lower spacer member attached to one another with a lower fastening device, the lower retainer member and the lower spacer member collectively coupled to the lower portion of the at least one o-ring, the upper retainer member and the upper spacer member collectively coupled to the upper portion of the at least one o-ring, the at least one o-ring positioned vertically relative to a horizontal surface of the upper assembly and a horizontal surface of the lower assembly, wherein the upper assembly and the lower assembly are removably coupled to one another by the at least one o-ring, wherein the upper assembly is removably attached to the first structure and the lower assembly is removably attached to the second structure; and
wherein the upper fastening device includes a pair of stop members each configured to spatially extend through a corresponding pair of apertures in the lower assembly such that the corresponding pair of apertures act as a travel limit when the vibration reduction device is in use to control movement of the upper assembly relative to the lower assembly.

27. The device of claim 26 wherein the pair of stop members each includes a mounting device removably attached to the first structure.

28. The device of claim 26 wherein the device is adapted to selectively include or exclude a plurality of o-rings, wherein the selected plurality of resilient vibration dampeners each includes at least one of a predetermined characteristic comprising at least one of a deflection rate, size, shape, thickness, color, elasticity, resilience, permeability, material, tensile strength, or compression strength, such that the selection of the predetermined characteristics of the plurality of o-rings is determinative of a load coupled to the frame mount and a vibration caused by the structure when the device is in use.

29. The device of claim 27 wherein the at least one o-ring includes an aperture and an outer area and an inner area, wherein the upper portion of the o-ring is coupled between the upper retainer member and the upper spacer member, such that a portion of the inner area of the upper portion of the o-ring is biased against a portion of an upper surface of the upper spacer member, and such that a portion of the outer area of the upper portion of the o-ring is biased against a portion of a lower surface of the upper retainer member, the upper retainer member including at least one slot in which to receive said upper portion of the o-ring, wherein the at least one slot is adapted to at least partially expose the upper portion of the o-ring, and wherein the upper spacer member is partially positioned through the aperture of the o-ring.

30. The device of claim 26 wherein the at least one o-ring includes an upper portion coupled between the upper retainer member and the upper spacer member, the upper retainer member including at least one slot in which to receive said upper portion of the o-ring, and wherein the upper spacer member is partially positioned through the aperture of the o-ring, and further wherein a lower portion of the o-ring is coupled between the lower retainer member and the lower spacer member, the lower retainer member including at least one slot in which to receive said lower portion of the o-ring, and wherein the lower spacer member is partially positioned through the aperture of the o-ring.

31. The device of claim 26 further comprising comprises a first plurality of stop members attached to the upper assembly and a second plurality of stop members attached to the lower assembly, wherein the first plurality of stop members each extend through corresponding apertures in the lower assembly, and wherein the second plurality of stop members each extend through corresponding apertures in the upper assembly, wherein the corresponding apertures of the upper and lower assemblies act as a travel limit when one of the upper assembly or lower assembly is displaced relative to the other one of the upper assembly or lower assembly.

32. The device of claim 26 wherein the lower fastening device includes a pair of supplemental stop members configured to each extend through a pair of corresponding apertures in the upper assembly, and wherein the pair of supplemental stop members each includes a mounting device removably attached to the second structure.

33. A vibration reduction device for reducing the amount of vibration transferred from a carrier to an electronic device to be carried to the carrier, the device comprising:
a lower assembly adapted to be fixedly coupled to the carrier, the lower assembly having an upper surface oriented to be facing upward during use;
an upper assembly adapted to be fixedly coupled to the electronic device, the upper assembly having a lower surface oriented to be facing downward during use, at least a portion of the upper assembly being positioned directly above at least a portion of the lower assembly such that the upper surface and lower surface are facing each other during use; and
at least one compressible, resilient body positioned between the upper surface of the lower assembly and the lower surface of the upper assembly, such that the weight of the electronic device is borne by the at least one compressible, resilient body when the vibration reduction device is used to carry the electronic device from the carrier, whereby at least some the vibration of the carrier is absorbed by the at least one compressible, resilient body instead of being transferred to the electronic device.

34. A vibration reduction assembly for absorbing at least some of the vibration propagating from a first structure to a second structure, the assembly comprising:
a first retainer member adapted to be rigidly coupled to the first structure;
a second retainer member adapted to be rigidly coupled to the second structure, the entire second retaining member being spaced apart from the entire first retainer member such that there is no direct contact between the first and second retainer members; and
at least one resilient spacer positioned at least partially between and in contact with the first and second retainer members, the at least one resilient spacer having an first portion and a second portion, the first portion in contact with the first retainer member and the second portion in contact with the second retainer member, the at least one resilient spacer adapted to at least partially absorb vibration propagating from the first retainer member and the second retainer member.

35. The device of claim 34 wherein the at least one resilient spacer is at least partially comprised of material having resilient properties.

36. The device of claim 35 wherein the at least one resilient spacer comprises an o-ring.

37. The device of claim 34, further comprising a third retainer member, the third retainer member being coupled to one of the first and second retainer member to retain the at least one resilient spacer therebetween.

38. The device of claim 37 wherein at least one stop member is coupled to the at least one spacer member for at least partially controlling displacement of the first retainer member relative to the second retainer member.
